(19) United States
(12) Patent Application Publication
(10) Pub. No.: US 2018/0293273 A1
(43) Pub. Date: Oct. 11, 2018

(54) INTERACTIVE SESSION

(71) Applicant: Lenovo (Singapore) Pte. Ltd., Singapore (SG)

(72) Inventors: Ming Qian, Cary, NC (US); Song Wang, Cary, NC (US); Jian Li, Chapel Hill, NC (US)

(21) Appl. No.: 15/481,583

(22) Filed: Apr. 7, 2017

(51) Int. Cl. G06F 17/30; G06F 3/16

(52) U.S. Cl. CPC G06F 17/30424; G06F 3/167

(57) ABSTRACT

One embodiment provides a method, comprising: receiving, at an information handling device, an indication to begin an interaction session, wherein the interaction session comprises receiving at least one user input and providing at least one output responsive to the at least one user input; determining, using a processor, if the interaction session has concluded; and responsive to determining that the interaction session has not concluded, receiving another at least one user input and providing another at least one output responsive to the another at least one user input. Other aspects are described and claimed.

### BACKGROUND

Information handling devices (“devices”), for example smart phones, tablet devices, laptop computers, smart speakers, and the like, may employ voice-activated or voice-capable digital assistants (“digital assistants”) that are capable of receiving voice input data and generating output associated with that data. One type of input data that may be received corresponds to a user query. Advances in technology have enabled digital assistants to search through an array of data sources to provide (e.g., using vocal output, textual output, etc.) users with a response to the query.

### BRIEF SUMMARY

In summary, one aspect provides a method, comprising: receiving, at an information handling device, an indication to begin an interaction session, wherein the interaction session comprises receiving at least one user input and providing at least one output responsive to the at least one user input; determining, using a processor, if the interaction session has concluded; and responsive to determining that the interaction session has not concluded, receiving another at least one user input and providing another at least one output responsive to the another at least one user input.

Another aspect provides an information handling device, comprising: a processor; a memory device that stores instructions executable by the processor to: receive an indication to begin an interaction session, wherein the interaction session comprises receiving at least one user input and providing at least one output responsive to the at least one user input; determine if the interaction session has concluded; and responsive to determining that the interaction session has not concluded, receive another at least one user input and provide another at least one output responsive to the another at least one user input.

A further aspect provides a product, comprising: a storage device that stores code, the code being executable by a processor and comprising: code that receives an indication to begin an interaction session, wherein the interaction session comprises receiving at least one user input an providing at least one output responsive to the at least one user input; code that determines if the interaction session has concluded; and code that receives, responsive to determining that the interaction session has not concluded, another at least one user input and providing another at least one output responsive to the another at least one user input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of interacting with a digital assistant.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently interact with devices to search for answers to various questions they may have. One method of interacting with a device is to use digital assistant software employed on the device (e.g., Siri® for Apple®, Cortana® for Windows®, Alexa® for Amazon®, etc.). Users may provide query input (e.g., voice input, touch input, keyboard input, etc.) to the digital assistant and, responsive to receiving the query input, the digital assistant may provide output (e.g., audible output, textual output, visual output, a combination thereof, etc.) associated with the results of the user's query. For example, a user may ask the digital assistant to determine what the fastest route from home to work may be. Responsive to receiving the user query, the digital assistant may open a mapping application with a highlighted route and/or provide vocal output describing the route (e.g., “the fastest route to travel from home to work is to take Highway 55”).

Conventionally, digital assistant interaction is generally limited to one interaction session, where the interaction session is composed of query input by the user followed by output provided by the digital assistant. Following this interaction session, conventional digital assistants are unable to process additional user query input related to either the initial user query or to the provided output. Therefore, current digital assistants are unable to provide various “follow up” outputs such as explanations regarding how or why they provided the original output, additional outputs responsive to additional user queries, additional suggestions, and the like. For example, using the aforementioned mapping example, after providing the user with a highlighted route, a conventional digital assistant may be unable to process another user query related to the original output, e.g., “why did you think that was the best route?”

An existing solution requires users to begin a new interaction session with the digital assistant specifically focused on the follow up query. For example, using the aforementioned mapping example, a user may need to query the digital assistant, in a separate interaction round, to provide traffic information data so that the user can deduce why the digital assistant provided the directions that they did. However, starting this new interaction session is both burdensome and time-consuming. Additionally, sometimes multiple interaction sessions are required to sufficiently answer the follow up query. In cases where the digital assistant is unable to provide sufficient output to the user's follow-up query, even in multiple interaction sessions, another existing solution requires users to use another application (e.g., Google, Wikipedia, etc.) to search for an answer to this query. However, this solution is also burdensome to the user and provides great difficulty to users who are unable to interact with a display screen. For example, a user may be engaged in an activity where either their hands, visual focus, or both are required elsewhere (e.g., while driving, exercising, etc.) and may not be able to attain an answer to their query until they are in a situation where they can safely visualize the contents on a display. Therefore, a user may not be able to attain an answer to their query in a timely fashion.

Accordingly, an embodiment may provide a method for interacting with a digital assistant. In an embodiment, an indication to begin an interaction session may be received at a device. The interaction session may comprise user input provided by a user and output, responsive to the user input, provided by a digital assistant employed by the device. For example, this initial interaction session may be similar to current interaction sessions, where the user provides a single input and receives a single output and the session in then completed. In an embodiment, the user input may comprise a user query. An embodiment may then access at least one data source associated with the user input in order to provide an output responsive to the user query. Subsequent to providing the output, an embodiment may determine whether the interaction session with the digital assistant has concluded. Responsive to determining that the interaction session has not concluded, an embodiment may receive additional user input and provide additional output responsive to the additional user input. Such a method enables users to interact with a digital assistant in a more natural fashion and also enables users to attain relevant information more quickly and without having to provide unnecessary additional information that was just or previously provided by the user.

The illustrated example embodiments will be best understood by reference to the figures. The following description is intended only by way of example, and simply illustrates certain example embodiments.

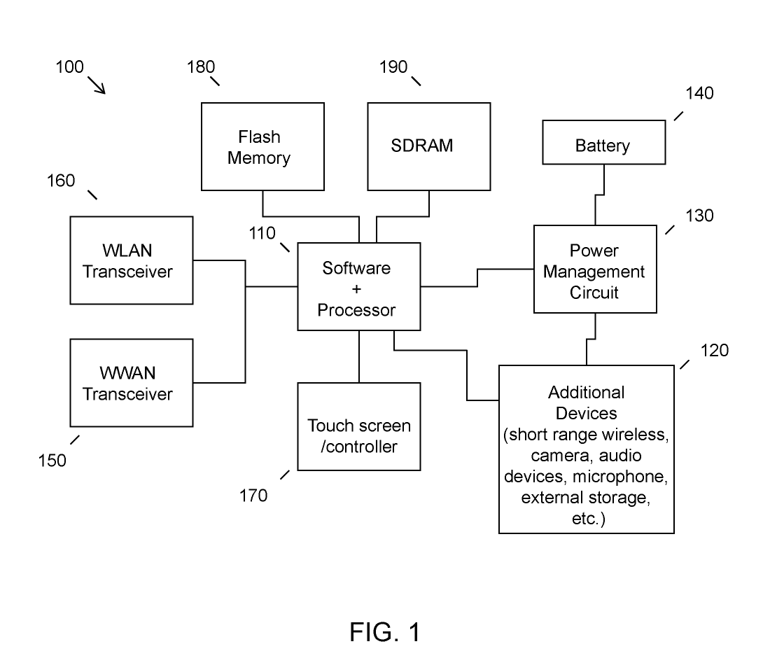

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

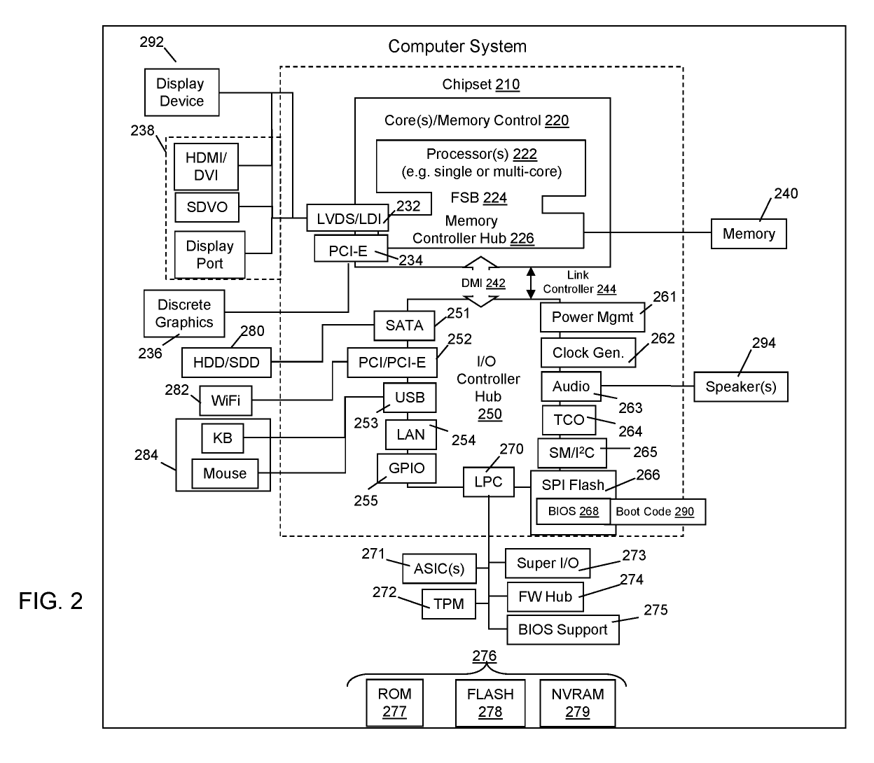

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may include digital assistants that a user may interact with and may provide output responsive to user input. For example, the circuitry outlined in FIG. 1 may be implemented in a tablet or smart phone embodiment, whereas the circuitry outlined in FIG. 2 may be implemented in a personal computer embodiment.

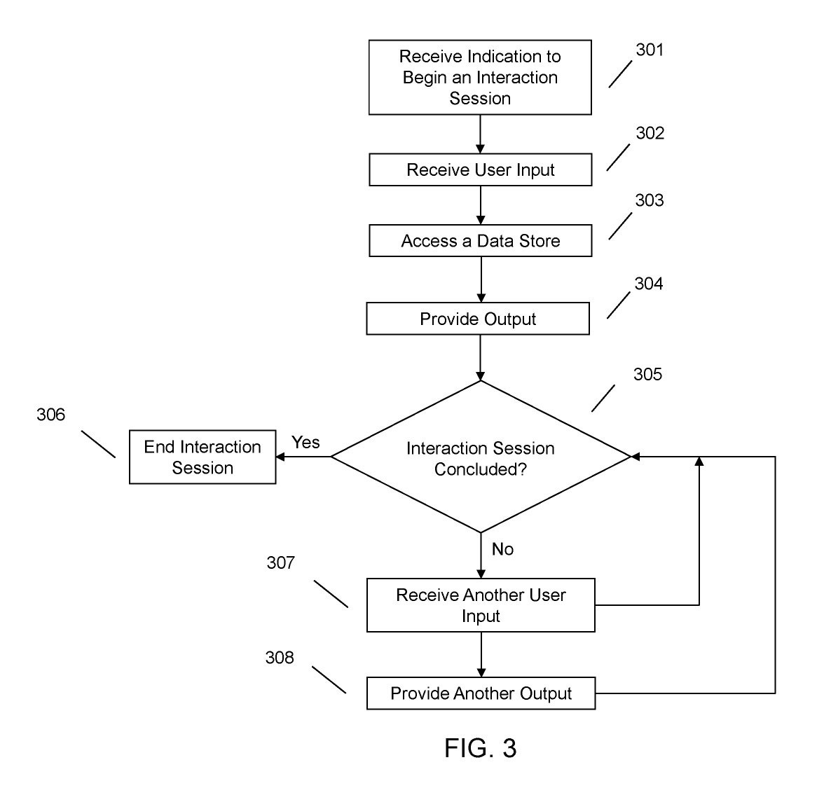

Referring now to FIG. 3, an embodiment may provide methods for interacting with a digital assistant. At 301, an embodiment may receive an indication to begin an interaction session. In an embodiment, the indication may be a wakeup action provided by a user (e.g., one or more wakeup words, a depression of a button for a predetermined length of time, a selection of a digital assistant icon, etc.). In an embodiment, the wakeup action may be provided prior to or in conjunction with the user input. For example, a user may provide the vocal input, “Alexa, what is the fastest route from home to work?” In this scenario, “Alexa” is the wakeup word and upon identification of the wakeup word an embodiment may prime the system to listen for additional user input. Responsive to the identification of the wakeup action, an embodiment may initiate an interaction session.

The system may also be programmed to not require a wakeup action. For example, the system may simply “listen” to the user and determine when the user is providing input directed at the system. The interaction session may then be initiated when the system determines that the user input is directed to the system. As discussed above and in more detail below, in one embodiment, the interaction session may comprise at least one user input, which may include a user query, and at least one user output.

At 302, an embodiment may receive user input (e.g., voice input, touch input, etc.) including or associated with a user query at a device (e.g., smart phone, tablet, laptop computer, etc.). In an embodiment, the device may employ digital assistant software capable of receiving and processing user input and subsequently providing output (e.g., audible output, textual output, visual output, etc.) corresponding or responsive to the user input. In an embodiment, the user input may be any input that requests the digital assistant to provide a response. For example, the user may ask the digital assistant a general question about a topic, the user may ask the digital assistant to provide directions to a location, the user may ask the digital assistant's opinion on a topic, the user may make a statement which allows a response, etc.

In an embodiment, the user input may be received at an input component (e.g., microphone, display, keyboard, etc.) of the device. In one embodiment, the user input may be voice input and the voice input may be received by a speech capture device (e.g., a microphone, etc.) associated with the device. In one embodiment, the speech capture device may be integral to the device. For example, the speech capture device may be a microphone integrated into the device. Alternatively, the speech capture device may be operatively coupled to the digital assistant device via a wireless or wired connection. For example, the speech may be captured using a microphone integral to a user device and then transmitted to another device for processing via a wired or wireless connection.

At 303, an embodiment may access at least one data store associated with the user input. The data store may be found locally on the device (e.g., local storage, removable storage, etc.) or may be found at an accessible remote location (e.g., the cloud, another device, network storage, websites, etc.). In an embodiment, the data store may be a single data store. For example, responsive to the user input “what are the best food options in the area?” an embodiment may access, for example, a website associated with local restaurant rankings. In an embodiment, more than one data store may be accessed. For example, responsive to a user query requesting a digital assistant to display the fastest route to a particular location, an embodiment may access a data store associated with a mapping application as well as a data store associated with current traffic data. In an embodiment, the multiple data stores may be accessed sequentially or substantially simultaneously.

At 304, an embodiment may provide output responsive to the user query. In an embodiment, the output may be audio output, textual output, haptic output, a combination thereof, or the like. In an embodiment, the output may be vocal output provided though a speaker, another output device, and the like. In an embodiment, the output device may be integral to the device or may be located on another device. In the case of the latter, the output device may be connected via a wireless or wired connection to the device. For example, a smart phone may provide instructions to provide audio output through an operatively coupled smart watch.

In an embodiment, the output may comprise a statement, another query, or the like, that is responsive to the user query. In an embodiment, the output may comprise a suggestion associated with the user query. For example, responsive to the user input “what are the best food options in the area?” an embodiment may access, for example, a data source associated with restaurant rankings and provide a ranked list of restaurants based on the accessed rankings as suggestions for the user. In an embodiment, the output may comprise a clarification output associated with the user query. For example, responsive to receiving user input the digital assistant is unable to process (e.g., as a result of bad clarity, incomplete or partial user input, too complex of a question, etc.), an embodiment may request clarification regarding a portion of the input or all of the input. The clarification output may comprise a statement such as “I do not know what that means,” a query such as “Can you please clarify what that means?”, or a combination thereof such as “I do not know what that means, can you please clarify?” In an embodiment, the output may comprise a satisfaction query associated with the user query. For example, the satisfaction query may be part of the output and may be a statement such as “are you satisfied with this answer?” The aforementioned output examples are not intended to be limiting and other output examples may be provided.

In an embodiment, a digital assistant may store user inputs and may rely on the information associated with the stored user inputs to provide output at a later time. For example, a user may provide to the digital assistant the user input, “my favorite restaurant is Restaurant X,” which the digital assistant may record, store, and associate with one or more users. At another time, a user may query the digital assistant to “provide directions to my favorite restaurant.” An embodiment may then access the stored input related to the user's favorite restaurant to provide directions to Restaurant X, without the user expressly saying that they want to go to Restaurant X. The user inputs may be stored locally (e.g., on the device), remotely (e.g., the cloud, network storage location, etc.), or a combination thereof.

In an embodiment, multiple users may access and use a single device. For example, multiple users may have the ability to access a device, or a digital assistant stored on a device, by logging into a user profile. In such a situation, an embodiment may store and keep separate user inputs associated with the different user profiles. Each user may gain access to a user profile on a device by providing, for example, user identification data (e.g., a digital fingerprint, user-associated passcode, user credentials, etc.) to an input field or an input location associated with the device. Subsequent to granting a user access to their user profile, an embodiment may have access to all the stored inputs associated with that user. For example, User A may have previously provided that Restaurant X is their favorite restaurant while User B may have previously provided that Restaurant Y is their favorite restaurant. Subsequent to identifying that a user profile associated with User A has been accessed and upon receiving query input to “provide directions to my favorite restaurant,” an embodiment may provide directions to Restaurant X instead of Restaurant Y.

At 305, an embodiment may determine whether the user interaction session has concluded. In an embodiment, the determination may comprise identifying that a predetermined time interval (e.g., 5 seconds, 10 seconds, etc.) has passed where no additional user input has been received after the output was provided. If the predetermined time interval has passed and no additional user input was received, an embodiment may determine that the session has been concluded and vice versa.

In an embodiment, the determination may comprise identifying another user input containing one or more predetermined concluding words and/or phrases. For example, subsequent to providing an output, an embodiment may receive another user input comprising concluding words such as “Okay,” “Thank you,” etc. Upon identification of the one or more predetermined concluding words and/or phrases, an embodiment may determine that the interaction session has been concluded. The predetermined concluding words may be designated by a user or may be preset on the application and/or device supporting the digital assistant.

In an embodiment, the determination may comprise determining that additional user input, provided after the output, is or is not associated with the output. An embodiment may determine whether the subsequent user input is associated with the output by analyzing the subsequent user input (e.g. using contextual analysis, word parsing, word matching, a combination thereof, etc.). Responsive to determining that the subsequent user input is associated with the output, an embodiment may determine that the interaction session has not been concluded. In an embodiment, all of the aforementioned methods of determining whether the user interaction session has been concluded may be utilized separately or in combination. Responsive to determining that the interaction session has concluded, at 305, an embodiment may end the interaction session at 306.

Responsive to determining that the interaction session has not concluded, at 305, an embodiment may receive another user input at 307. In an embodiment, the subsequent user input may be provided to the device using the same input method as the first user input. For example, if the first user input was provided vocally, the subsequent user input may also be provided vocally. Alternatively, the subsequent user input may be provided to the device using a different input method. For example, if the first user input was provided vocally, the subsequent user input may be provided using touch input. In an embodiment, the subsequent user input may be provided by the user who provided the first user input or may be provided by a different user. In an embodiment, the subsequent user input may be provided after the output and may be responsive to the output and/or the original user input. In an embodiment, the subsequent user input may comprise a statement or another user query.

In an embodiment, the subsequent user input may comprise elaboration input responsive to a clarification output. For example, responsive to receiving an output requesting clarification such as “I do not know what that means, can you please clarify?” a user may provide additional details regarding the original user query or portions of the original user query. An embodiment may then provide, at 308, another output responsive to the clarification input. In an embodiment the output responsive to the clarification input may be a confirmation statement (e.g., “Thank you, I understand now”, etc.), result output (e.g., results associated with the clarified input), another clarification query, other types of output associated with the clarified input, etc.

In an embodiment, the subsequent user input may comprise input responsive to a satisfaction query present in the output. For example, responsive to receiving the satisfaction query provided by the digital assistant, “are you satisfied with this answer,” a user may provide an answer in the positive (e.g., “yes I am”, etc.) or may provide an answer in the negative (e.g., “no, I am not”, etc.). Responsive to receiving a negative subsequent user input, an embodiment may provide, at 308, another output comprising at least one of a statement or a query. For example, the second output may comprise a statement such as an alternate suggestion (e.g., if the original output corresponded to a selection of a list of suggestions), a conciliatory statement (e.g., “I'm sorry you were not satisfied with my answer”, etc.), another statement, etc. In another example, the second output may comprise a query regarding why the user is not satisfied with the original output, a query regarding how the digital assistant may provide better output, another query, etc.

In an embodiment, the subsequent user input may comprise a second user query. In an embodiment, the second user query may comprise a clarification query regarding the output. For example, in response to the first user query “what is the fastest route from home to work” a digital assistant may provide a set of directions to the user. A user may then provide the second user query “how did you determine that?” Responsive to receiving the second user query, an embodiment may provide, at 308, another output explaining how and/or why it provided the first output. In an embodiment, the explanation may include citing sources (e.g., Wikipedia®, Google® search results, etc.), providing additional information to the user (e.g., visual information such as maps, charts, etc.), a combination thereof, and the like.

After both or either, receiving the subsequent user input at 307 and providing the subsequent output at 308, an embodiment may again determine, at 305, whether or not the interaction session has concluded. For example, if an embodiment determines after receiving another user input that the interaction session has concluded, an embodiment may not proceed to 308 and provide another output. Additionally, subsequent to providing another output, if an embodiment determines that the interaction session has not concluded, an embodiment may receive, at 307, additional user input. In an embodiment, responsive to determining that the interaction session has not concluded, an embodiment may receive additional input without requiring the original wakeup word to be repeated.

The various embodiments described herein thus represent a technical improvement to conventional digital assistant interaction techniques. Using the techniques described herein, an embodiment may determine whether or not an interaction session has concluded and, based on that determination, an embodiment may receive additional user inputs and provide additional outputs. Such techniques provide a more natural interaction experience with a digital assistance and may enable users to attain additional information regarding why a digital assistant provided the output that they did.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to begin an interaction session, wherein the interaction session comprises receiving at least one user input and providing at least one output responsive to the at least one user input;
determining, using a processor, if the interaction session has concluded; and
responsive to determining that the interaction session has not concluded, receiving another at least one user input and providing another at least one output responsive to the another at least one user input.

2. The method of claim 1, wherein the at least one output comprises a suggestion associated with a user query of the at least one user input.

3. The method of claim 1, wherein the at least one output comprises a clarification query associated with a user query of the at least one user input.

4. The method of claim 3, wherein the another at least one user input comprises elaboration input responsive to the clarification query.

5. The method of claim 1, wherein the at least one output comprises a satisfaction query.

6. The method of claim 5, wherein the another at least one user input comprises input responsive to the satisfaction query and wherein the another at least one output comprises at least one of a query and a statement.

7. The method of claim 1, wherein the another at least one user input comprises another user query, wherein the another user query is associated with the at least one output.

8. The method of claim 7, wherein the another user query comprises a clarification query.

9. The method of claim 1, wherein the another at least one output comprises an explanation output associated with the at least one output.

10. The method of claim 9, wherein the explanation output comprises references supporting the at least one output.

11. An information handling device, comprising:
a processor;
a memory device that stores instructions executable by the processor to:
receive an indication to begin an interaction session, wherein the interaction session comprises receiving at least one user input and providing at least one output responsive to the at least one user input;
determine if the interaction session has concluded; and
responsive to determining that the interaction session has not concluded, receive another at least one user input and provide another at least one output responsive to the another at least one user input.

12. The information handling device of claim 11, wherein the at least one output comprises a suggestion associated with a user query of the at least one user input.

13. The information handling device of claim 11, wherein the at least one output comprises a clarification query associated with the user query.

14. The information handling device of claim 13, wherein the another at least one user input comprises elaboration input responsive to the clarification query.

15. The information handling device of claim 11, wherein the at least one output comprises a satisfaction query.

16. The information handling device of claim 15, wherein the another at least one user input comprises input responsive to the satisfaction query and wherein the another at least one output comprises at least one of a query and a statement.

17. The information handling device of claim 11, wherein the another at least one user input comprises another user query, wherein the another user query is associated with the at least one output.

18. The information handling device of claim 17, wherein the another at least one user query comprises a clarification query.

19. The information handling device of claim 11, wherein the another at least one output comprises an explanation output associated with the at least one output.

20. A product, comprising:
a storage device that stores code, the code being executable by a processor and comprising:
code that receives an indication to begin an interaction session, wherein the interaction session comprises receiving at least one user input an providing at least one output responsive to the at least one user input;
code that determines if the interaction session has concluded; and
code that receives, responsive to determining that the interaction session has not concluded, another at least one user input and providing another at least one output responsive to the another at least one user input.
